(19) United States
(12) Patent Application Publication
(10) Pub. No.: US 2015/0202633 A1
(43) Pub. Date: Jul. 23, 2015

(54) Garbage Disposal Controls System

(71) Applicant: Alan Mark Perkins, BEAVERTON, OR (US)

(72) Inventor: Alan Mark Perkins, BEAVERTON, OR (US)

(73) Assignee: Alan Mark Perkins, Beaverton, OR (US)

(21) Appl. No.: 14/158,826

(22) Filed: Jan. 19, 2014

(51) Int. Cl. B02C 25/00; G05G 1/52; E03C 1/266; G05G 1/30

(52) U.S. Cl. CPC B02C 25/00; G05G 1/30; G05G 1/52; E03C 1/2665

(57) ABSTRACT

A Garbage Disposal Controls System utility invention that solves the inconvenience problems with using a Garbage Disposal (GD) while also preserving and enhancing safety of the GD for the User. The GD Controls System is applicable to, and provides unique and new functionality to, residential and industrial commercial applications.

The invention features are 1) an ability to operate the GD by foot or knee action, 2) an activation delay for safety purposes, delay time being variable and User settable, 3) timed activation of safety devices, 4) a One-Touch capability which controls length of run time, such run time being variable and User settable, 5) automatic water injection during operation, 6) two form factors, which are the Add-On version and the Integrated version.

The Garbage Disposal Controls System relies upon micro-controller(or micro-processor) based software that manages sensing and signal interpretation, and carries out sequences of activation actions in timed fashion.

### REFERENCES CITED: US PATENT DOCUMENTS

U.S. Pat. No. 6,636,136 B1, October 2003 Vetter—

### TECHNICAL FIELD

This invention relates to garbage disposal (GD) systems in residential applications and industrial commercial applications.

### STATE OF PRIOR ART

The common garbage disposal in residential and commercial locations lacks safety warning features, lacks convenience features, is almost universally operated by a hand action, and often has the switch located away from the User. The current state of the art is inconvenient to use, impedes productivity, and is not as safe as it should be. Listed herein is a summary of the deficiencies found in the current state of the art:

1. All current implementations inconveniently require either:
a) Removing a wet hand/hands from the sink to activate the GD switch;
   Using a towel to dry off, or dripping on the counter and floor.
   Stepping away from the sink if the switch is not close enough.
   Requiring to stay at the switch while the GD is running
   Unable to be at the sink to manage the feeding of material to the GD.
b) Or, asking someone nearby to push the switch for the User.

2. Current implementations lack safety features:
a) No visual warnings such as Light Emitting Diode (LED) indicators.
b) No audible warning such as beepers.
c) No start delays to operation.

3. Current implementations lack convenience features:
a) No One-Touch operation.
b) No automatic water injection.

4. The deficiencies of the current state of art waste time, negatively impact productivity, create wet towel to be laundered, and are generally incongruous with smoothly accomplishing tasks at the kitchen sink.

There are few previous commonly implemented solutions to the problems of the state of the art for garbage disposals.

One is patent U.S. Pat. No. 6,636,135 B1 issued Oct. 21, 2003, which is titled REED SWITCH CONTROL FOR A GARBAGE DISPOSAL. This previous patent has little intersection with the patent proposed and described in this submittal, because:
1. U.S. Pat. No. 6,636,135 B1 documents a reed switch for the counter-top that allows the user to activate the GD with his/her hand actions by moving the reed. This fails to address all but one of the issues with the current art.
   a) It does not provide safety features,
   b) It does not provide convenience features, and
   c) It still requires the User to stop work with hands at the sink to use it.

The state of the art that is currently available for common garbage disposals varies from residential to commercial. The residential solutions predominantly rely upon a mechanical switch located on the wall close to the sink or on the counter right beside the sink. These two variations are essentially the same design with the switch placed in different locations, which is still activated by hand motion. In that sense of hand activated, the U.S. Pat. No. 6,636,135 B1 patent solution is not different from the current state of the art except for using a reed switch instead of a mechanical switch.

Commercial implementations under current state of the art are sturdier and more ruggedized than residential versions, ruggedization being the design and manufacturing process whereby a system is made to be more impervious to environmental exposure such as vibration, temperature, and moisture. However, these commercial implementations still rely upon simple mounted switches to operate them by hand and the concept of operations is essentially the same as the residential implementations.

### PRESENTATION OF THE INVENTION

This Garbage Disposal Controls System represents a major step forward in the ease of use, convenience, and safety of the GD in the residential and industrial commercial environments while preserving the economics associated with currently marketed GDs. That is to say, the GD Controls System does not potentially add greatly to the cost of garbage disposals.

The standard GD installation in homes and many restaurants calls for the user to interrupt their work and dry their hands to operate the GD. This situation negatively impacts productivity and wastes time and resources. The GD Controls System utility invention that is the topic of this patent solves all of the listed problems with using a GD while also preserving and enhancing safety for the User. The key aspects of the design are:
1. The ability to operate the GD by foot action. This foot action can include but is not limited to, mechanical foot switches, solid state foot switches, laser sensors, sonic sensors, and Infrared (IR) sensors.
   a) The activation switch may also be placed in a location where the knee may activate the GD.
2. An activation delay for safety purposes, such delay being easily adjustable by the User and widely variable.
3. Activation of safety devices including but not limited to beepers, lights, and others. This patent is not limited to one particular safety device, but rather includes the ability to control/activate all variations of safety devices, and for a range of timing of activation of the devices.
   a) If the existing GD design includes an on-off switch that is wall mounted, that switch may remain in place and be used as an overall deactivation of the system, in cases where additional safety steps are desirable.
4. Convenience feature of One-Touch operation. The GD Controls System enables the User to adjust the length of operation of the One-Touch operation to a timing most suitable for their particular requirements.
5. Automatic injection of water into the GD while it is running This design may include a backflow prevention check valve if required by government agencies.
6. Easily packaged as an Add-On box for preexisting installations of GDs in residences, restaurants, and all other industrial installations.
7. With a form/fit/function (FFF) that can be miniaturized and integrated fully into existing GD products, and can meet requirements for small size, low power consumption, safety, longevity of use for warranty, and cost constraints.

The GD Controls System design has been prototyped in a range of variations, and tested to demonstrate function, form, reliability, and general feasibility of the concept.

See FIG. 3 and FIG. 4 for the discussion of the components of the GD Controls System. The GD Controls System consists of the following components:
1. CONTROLLER Box:
   a) The Add-On version has a standalone CONTROLLER box where the sensor signals are processed and action signals are sent out.
   b) The Integrated version has the CONTROLLER box inside of the Garbage Disposal, but with the same functions as the standalone version.
2. A sensor or series of sensors that are external to the CONTROLLER box and connected to the

CONTROLLER box with copper wire or optical wire, depending upon the sensor types. Sensors include mechanical switches such as the foot switch, optical switches such as the laser foot switch, and sonic switches such as motion detectors.
3. A safety transducer or series of safety transducers. These include audible beepers, standard LED lights, and ring LED lights.
   a) It should be known that some of these safety devices may integrate into the CONTROLLER box, such as the beeper.
   b) In the case of the Integrated version of the CONTROLLER, the ring LED and the beeper may or may not be included in the GD housing.

### BRIEF DESCRIPTION OF DRAWINGS

FIG. 1 shows the first general embodiment, that of the Residential application. This shows an under-sink wall-mounted CONTROLLER box that connects to power, connects to the GD, and adds safety light and beeper and foot-switch.

FIG. 2 shows a second general embodiment, that of the Commercial application. This is the most common situation found in restaurants with a sparse stainless steel large sink mounted into the floor against the wall. The CONTROLLER box here is wall mounted.

FIG. 3 is an example embodiment that aligns with the general embodiment shown in FIG. 1, showing the connections and main installed parts labeled.

FIG. 4 shows another example embodiment that aligns with the general embodiment shown in FIG. 2, which is the GD Controls System miniaturized and added as an Integrated component of the main Garbage Disposal unit.

FIG. 5 is the physical CONTROLLER box representation of the Add-On version of the GD Controls System.

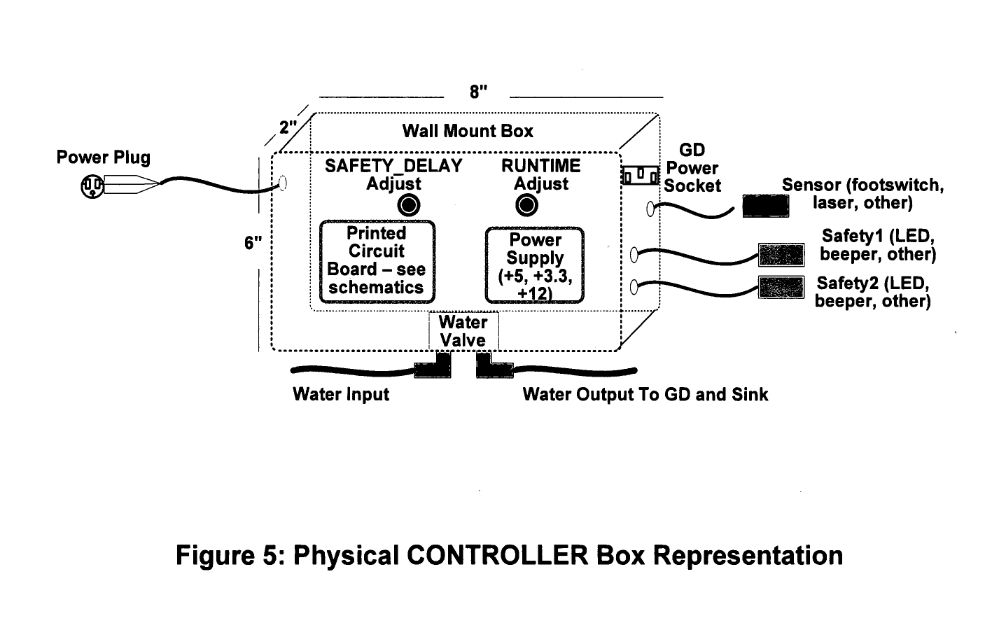

FIG. 6 is a particular version of the CONTROLLER logical schematic. Part numbers are not included because they can be varied over time due to size and cost requirements. The intelligence of this new concept of operations for the GD is captured in the software that runs on the MCU or CPU.

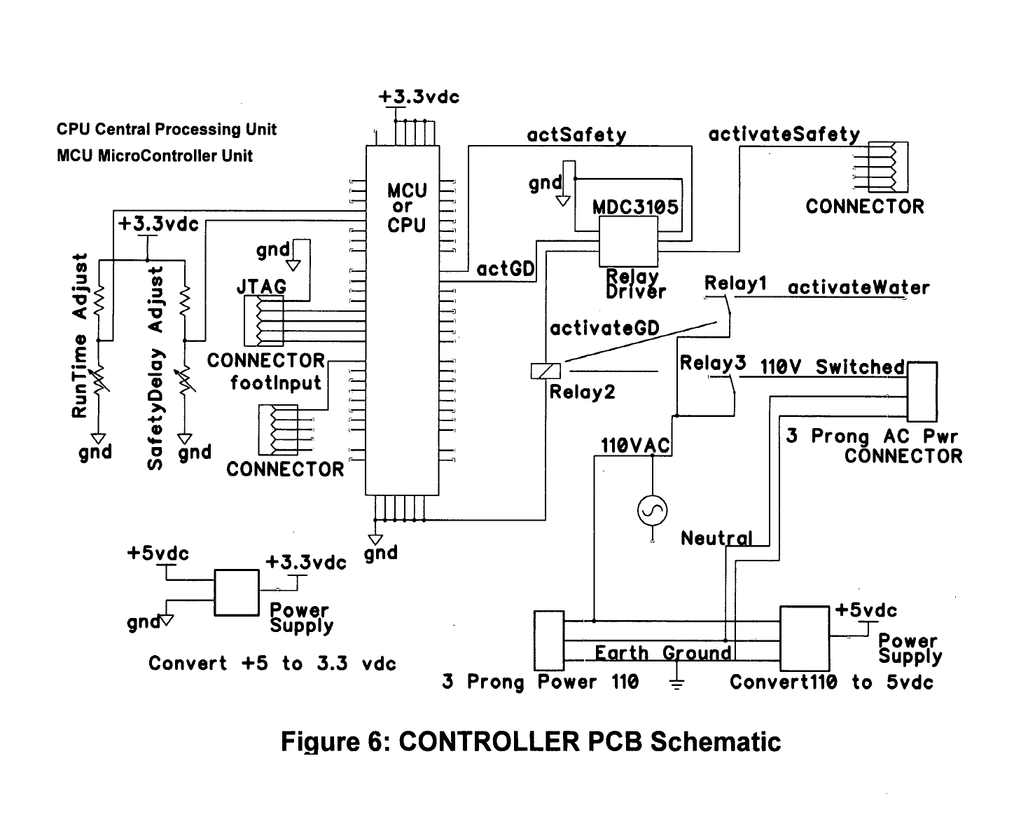

### DETAILED PRESENTATION OF PARTICULAR EMBODIMENTS

### General Embodiment 1

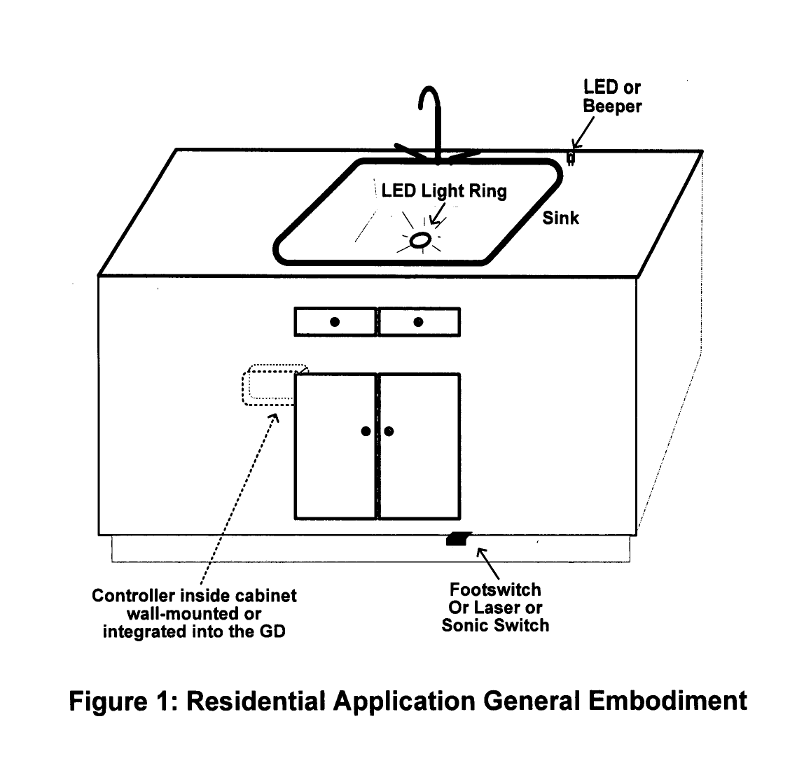

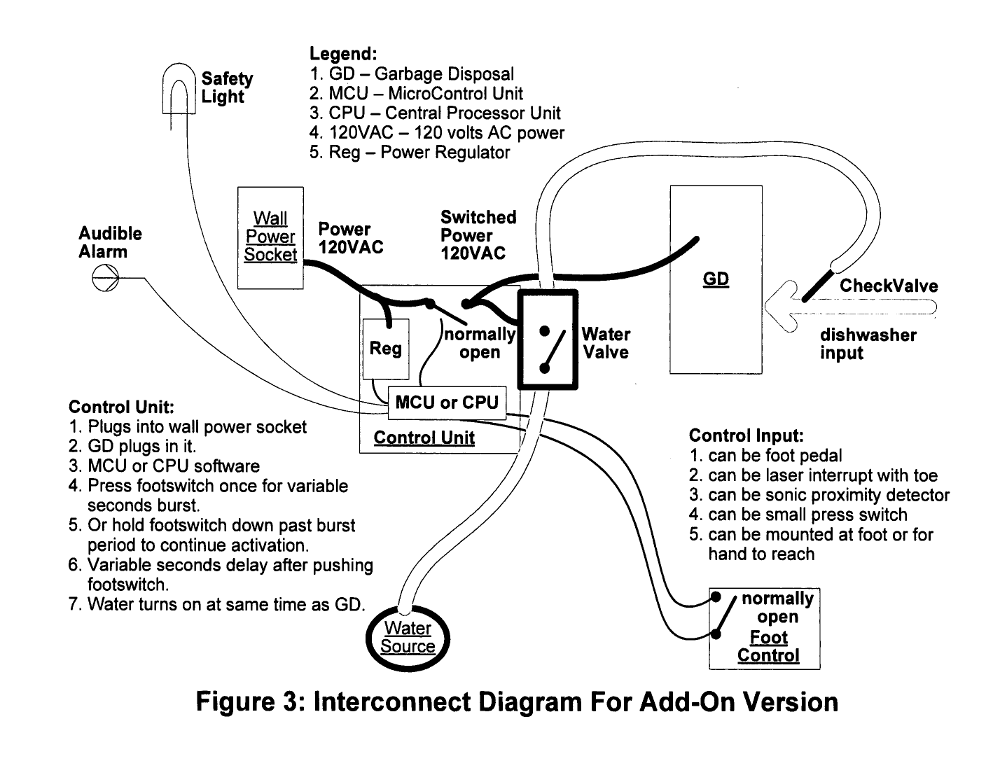

FIG. 1 and FIG. 3 show the first general embodiment of the GD Controls System, that of the Residential embodiment using the Add-On version of the GD Controls System. This system has been prototyped and fully tested in a field trial scenario. This embodiment has the following features:
1. Wall-mounted Add-On CONTROLLER box for an Add-On version GD installation in a residence.
   a) A power supply included within the CONTROLLER that runs on North American type 110 VAC at 60 hz, which generates all necessary DC voltages for digital electronics including +5 vdc and +3.3 vdc.
   b) The power to the GD is turned on and off based on using relays that are activated by the sensor actions:
   c) POWER RELAY Variations: mechanical relays, solid state relays, opto-isolated relays.
   d) As shown in FIG. 3, the CONTROLLER box is plugged into the wall mounted power socket under the sink.
   e) As shown in FIG. 3, the Garbage Disposal is plugged into the CONTROLLER box.
2. Foot activation:
   a) Using a mechanical single-pole single-throw (SPST) switch.
   b) ACTIVATION Action: Once the User presses the foot switch with his/her foot, a SAFETY_DELAY delay period is initiated.
   c) SAFETY_DELAY Feature: Said delay is variable and settable by the User, and may default to 2, 3, or 4 seconds from the factory. The SAFETY_DELAY period is settable on the CONTROLLER by varying the knob or screw labeled SAFETY_DELAY Adjust.
   d) SAFETY Features: At the start of the SAFETY_DELAY period, safety features are activated.
      Beepers and lights activate, and stay activated through the SAFETY_DELAY period and through the RUNTIME period.
      After the delay period, the GD begins to run for a period of time called RUNTIME. This RUNTIME setting may be adjusted by the User by varying the knob or screw labeled RUNTIME Adjust on the CONTROLLER.
      SAFETY_RESET Action: At any point after initiating the activation with foot action, an additional foot action will reset the system and turn off the GD and safety devices.
   e) ONE-TOUCH Activation: If the User only does a short activation action, then the delay will occur, followed by a settable period of GD operation. This is called One-Touch mode, and will be nominally set to 2 seconds SAFETY_DELAY delay and 12 seconds operation RUNTIME from the factory. The One-Touch operate mode may be varied by turning the potentiometer knob labeled RUNTIME Adjust for the run time period, and turning the potentiometer knob labeled SAFETY_DELAY Adjust for varying the SAFETY_DELAY period.
   f) SUSTAINED Activation: If the User keeps his/her foot activating the foot-switch past the One-Touch operation period, the GD and safety devices will continue to operate until the foot is removed, at which point the GD will stop running and the CONTROLLER will reset the sequence. This feature allows the User to extend the GD run time beyond the ONE-TOUCH RUNTIME period.
   g) This prototypes use some particular devices such as a SPST switch, however may be implemented with a wide variety of part selections while still relying upon the overall design described in this patent. This patent includes using a wide variety of parts based on cost, power, and size constraints to implement this design. (A reed switch is specifically excluded from this patent design).
   h) SWITCH and SENSOR Variations: SPST switch, double-pole single-throw switch, double-pole double-throw switch, visible laser switch, IR laser switch, and sonic switch can be used in manufacture of the GD Controls System.
3. Safety features:
   a) A beeper is inside the wall-mount CONTROLLER box.
   b) An LED ring light is shown installed inside the sink at the drain, however the LED ring light will be part of a later embodiment variation.
   c) An LED light is mounted on the counter beside the sink.
   d) Such safety devices are activated upon foot (or knee) action and execute safety actions before the GD begins running This time period of safety activation is variable and can be momentary up to many seconds depending upon what delay is selected by the User by turning the potentiometer knob labeled Safety Delay. Default safety delay setting is 2 seconds. This safety delay period may eventually be dictated as a standard by the agencies such as Underwriter Laboratories.
   e) SAFETY Variations: LED light, ring LED light, beeper, song bell, vibrator, incandescent light bulb.

### General Embodiment 2

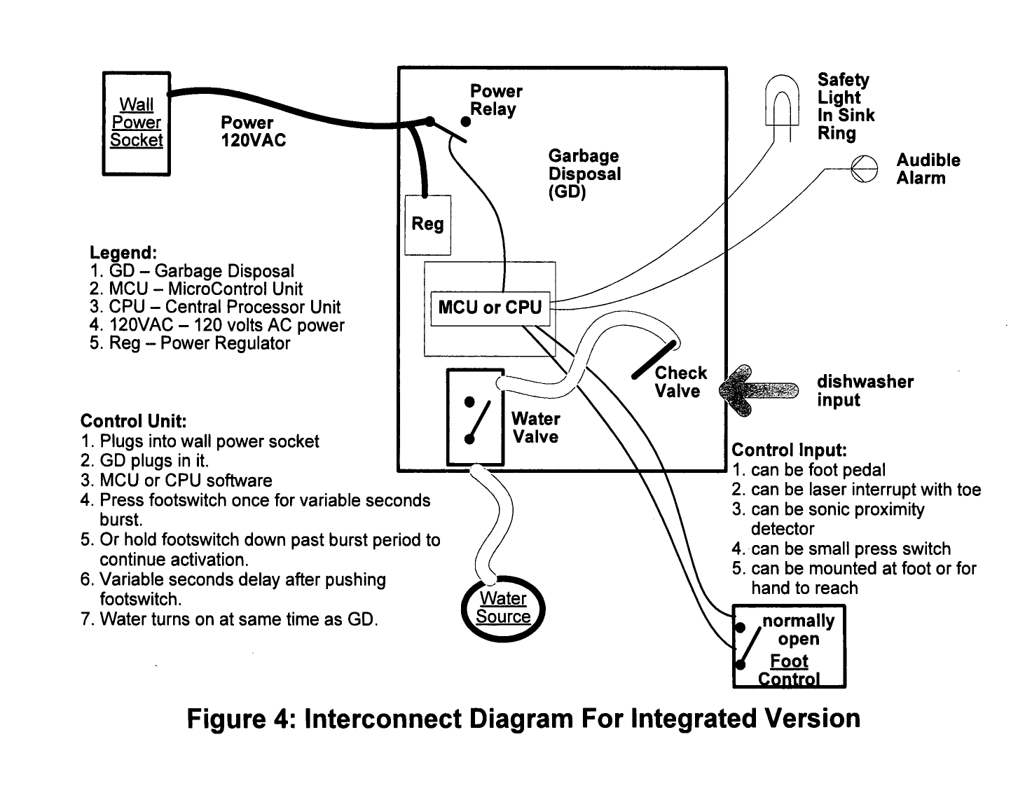

FIG. 1 and FIG. 4 show the general embodiment of the GD Controls System, that of the Residential embodiment using the Integrated version of the GD Controls System. Functions of this system have been prototyped and fully tested in a field trial scenario. This embodiment uses smaller parts, tighter spacing, more precision manufacturing, and shaped parts to fit inside the Garbage Disposal housing.

The Integrated embodiment may be combined with other Embodiments described herein, such as a variety of sensors and safety indicators.

### General Embodiment 3

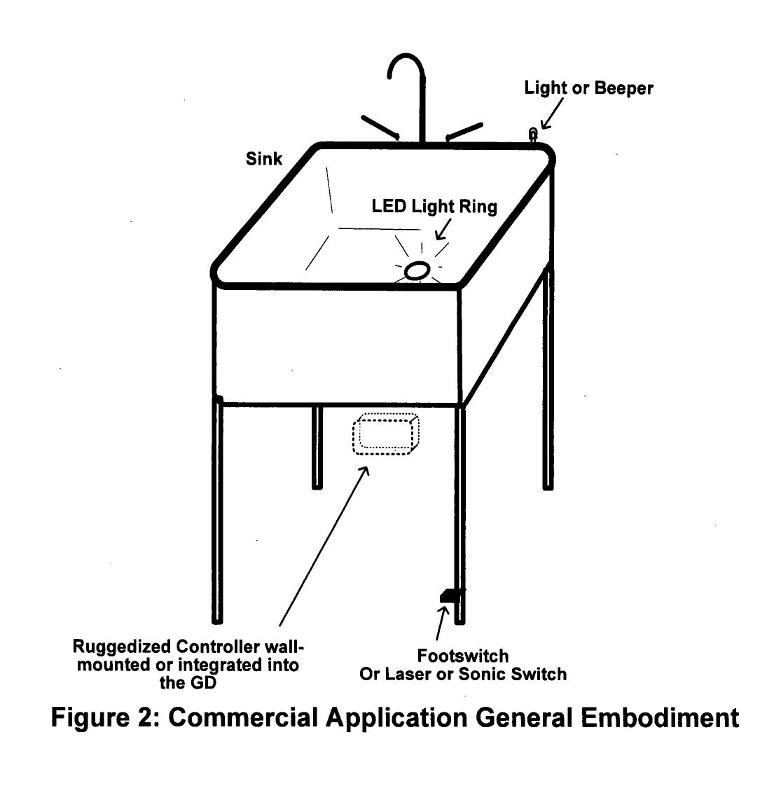

FIG. 2 and FIG. 3 show the second general embodiment of the GD Controls System, that of the Commercial embodiment using the Add-On version of the GD Controls System. This system has been prototyped and fully tested in a field trial scenario. This embodiment has the following features:
1. Wall-mounted Add-On CONTROLLER box for a standard GD installation in a Commercial location (Commercial locations include restaurants, fast food establishments, deli, bakeries, etc.).
2. A power supply included within the CONTROLLER that runs on North American type 110 VAC at 60 hz, and generated all necessary DC voltages for digital electronics.
3. Foot activation:
   a) Using an Infrared laser emitter to detect breaking the beam by foot motion.
      The laser is mounted pointing toward the floor.
      The floor has a reflector attached to the floor with adhesive.
      The IR beam reflects from the reflector back to the laser, which has a co-located IR sensor.
      When the foot action break the beam from reflecting back to the sensor, then the One-Touch operation is activated.
   b) The same activation delays are available to the User and settable by varying knob settings.
   c) The Commercial embodiment is a ruggedized and waterproof variation of the

CONTROLLER box. This is a stainless steel housing or other suitably ruggedized housing. The unit is suitable for and designed for long hours of use, by using techniques such as thicker circuit boards, heat sinks where appropriate, vibration resistance, and so on.

### General Embodiment 4

FIG. 2 and FIG. 4 show the general embodiment of the GD Controls System, that of the Commercial embodiment using the Integrated version of the GD Controls System. Functions of this system have been prototyped and fully tested in a field trial scenario. This embodiment uses smaller parts, tighter spacing, more precision manufacturing, and shaped parts to fit inside the Garbage Disposal housing.

The Integrated embodiment may be combined with other Embodiments described herein, such as using a variety of sensors and safety indicators.

### General Embodiment 5

This embodiment represents all of the general embodiments 1 through 4, but with power supplies based on 220 VAC power in both 50 hz and 60 hz variations. The basic functions of the CONTROLLER are the same as the other embodiments, however the power supplies are designed for locations such as Europe where the power supply sources differ from North America.

### EXAMPLE EMBODIMENTS

### Example Embodiment 1

This example embodiment is a variation of the general embodiment shown in FIG. 1, the residential application using the Add-On version of the GD Controls System. This embodiment shows a residential location where the GD Controls System is installed with these features:
1. The CONTROLLER box is mounted up inside the cabinet on the wall.
2. The CONTROLLER box is plugged into the power socket inside the cabinet.
3. The GD is plugged into the CONTROLLER box power socket.
4. A laser operated foot-switch:
   a) The Installer drills a hole into the cabinet base that extends over the floor area to mount the laser module.
   b) An adhesive backed reflector is placed on the floor beneath the laser source.
   c) The Installer moves the reflector until the LED indicator light on the laser source turns on, indicating that the reflection is returning to the laser sensor, then the Installer attaches the reflector to the floor at that location.
   d) When the User moves their foot over the reflector, this blocks the reflection and causes the activation sequences to occur.
5. Two safety indicators, which are the counter LED and the beeper.
   a) The beeper is mounted in the CONTROLLER wall-mount box.
   b) The counter-top LED is placed to the back of the sink and just to the right in clear view.

### Example Embodiment 2

This example embodiment is a variation of the general embodiment shown in FIG. 2, the commercial application using the Integrated version of the GD Controls System.:
1. The CONTROLLER is integrated into the GD, internal and out of sight.
   a) Exiting the GD are the sensors and safety wires.
2. The foot activation switch is mounted to the leg of the sink and sideways facing.
   a) The User activates the switch by pressing against it with his/her foot.
   b) The usual safe routing of wires to the GD is accomplished with wire covers and so forth.
3. Safety devices:
   a) There is a ring LED integrated into the GD sink drain, which lights up during the safety delay period and during the activation period.
   b) There is a beeper integrated directly into the GD.
   c) There is a third connection available to use for placing an LED safety light on the edge of the sink.

The invention claimed is:

1. A Garbage Disposal Controls System for a garbage disposal, wherein the improvement comprises managed activation capabilities, managed safety features, convenience features, timed sequences, and hands-free operation.

2. The Garbage Disposal Controls System in claim 1 using modern electronics, wherein the improvement comprises function control based upon micro-controller and/or micro-processor based electronics and standard commercial peripheral electronics of switched valves, power supplies, LEDs, beepers, and other commonly available peripheral devices.

3. The Garbage Disposal Controls System in claim 1 having a new concept of operations for residential applications, wherein the improvement comprises timed sequence operations that are tailored and unique to a Users preferences in a residential application, with a convenient One-Touch feature.

4. The Garbage Disposal Controls System in claim 1 having a new concept of operations for commercial applications, wherein the improvement comprises timed sequence operations that is tailored and unique to a Users preferences in a commercial application, with a convenient One-Touch feature.

5. The Garbage Disposal Controls System in claim 1 invented in two form factors, wherein the improvement comprises an Add-On version of GD Controls System that may be easily and quickly added by installation to most preexisting garbage disposal installations.

6. The Garbage Disposal Controls System in claim 1 invented in two form factors, wherein the improvement comprises an Integrated version of GD Controls System that may be built into a garbage disposal, with the features as an integral part of the garbage disposal.

7. The Garbage Disposal Controls System in claim 1 incorporating a unique control, wherein the improvement comprises a foot and/or knee User control that allows the User to continue using his/her hands to accomplish tasks at the sink while the garbage disposal and safety features are running

8. The foot or knee control in claim 7 implementable using a variety of components, wherein the improvement comprises using mechanical switches, solid state switches, laser sensing switches, optical switches, and sonic sensing switches for activation of the garbage disposal.

9. The Garbage Disposal Controls System in claim 1 incorporating safety features, wherein the improvement comprises a range of safety features which are implemented using devices that are activated by timed sequences.

10. The safety features in claim 9 include timed safety sequences, wherein the improvement comprises design and addition of variable and User-settable timed safety delays.

11. The safety features in claim 9 to include using a variety of safety devices, wherein the improvement comprises addition of beepers, Light Emitting Diodes, and incandescent lamps that are timed as part of a safe sequence.

12. The safety features in claim 9 to include using a variety of safety devices, wherein the improvement comprises addition of a new “ring LED” that is to be incorporated into the sink drain part of the Integrated version of the garbage disposal.

13. The safety features in claim 9 including a safe reset capability, wherein the improvement comprises a SAFE_RESET instant cutoff caused by an emergency activation interrupt action with the foot or knee.
